(19) United States
(12) Patent Application Publication
(10) Pub. No.: US 2008/0168823 A1
(43) Pub. Date: Jul. 17, 2008

(54) ROLLER FATIGUE TEST APPARATUS

(75) Inventors: Erik C. Maassen, Livonia, MI (US); Bryce W. Babcock, Saline, MI (US)

Correspondence Address: ARTHUR J. PLANTAMURA, ESQ.;GENERAL CHEMICAL PERFORMANCE PRODUCTS LLC., 90 EAST HALSEY ROAD, PARSIPPANY, NJ, 07054, US

(73) Assignee: GenTek Technologies Marketing Inc., Westfield, MI (US)

(21) Appl. No.: 11/623,930

(22) Filed: Jan. 17, 2007

(51) Int. Cl. G01N 3/56

(52) U.S. Cl. 73/7

(57) ABSTRACT

A machine suitable for evaluating finished cylindrical manufactured part that accurately simulates the performance of the intended use of the part in a cam-roller contact geometry using an actual manufactured part as the test specimen is provided. The machine is capable of evaluating the effects on the can finish and profile of the manufactured part. Three idler rollers ground to simulate the axial cam geometry are compressed into the outer diameter of the bearing as it rotates, duplicating the rolling action of a cam lobe. Because the cylindrical manufactured part to be tested is loaded evenly between the three idles, the test part experiences three stress cycles per revolution, accelerating the generation of fatigue spalling damage on the outside diameter. Load and speed are regulated using a closed loop control. Ease of replacing the part to be tested and servicing the idler rollers is an advantageous feature of the machine. A calibration fixture is provided for verifying that the machine is applying the specified load evenly on all three sides of the cylindrical manufactured part that is under test. Alternately the machine can be configured so as to enable the testing of three manufactured test specimens simultaneously. With the addition of a torque transducer, the torque generated between a journal bearing roller and shaft may be measured and monitored.

The invention relates to a device for testing a range of finished cylindrical roller elements in rolling contact fatigue and has the flexibility of being reconfigured to also test a range of tappets. More particularly, the invention relates to a device having the aforementioned capability afforded by the utilization of three equally-spaced load cylinders configured alternatively (a) with means comprising cylindrical shaped idler rollers to apply a line contract load to three locations on a rotating cylindrical element undergoing testing: (b) with means of holding tappets or similar assemblies and loading them into a single driving idler roller; or (c) with means of holding a roller and axle assembly and loading them against a single driving roller and measuring the torque exerted on the axle.

### BACKGROUND OF THE INVENTION

Known prior art test devices of this kind, for example, those disclosed in the Patent to Minter, U.S. Pat. No. 4,452,065 and the patent to Bacigalupo, et al., U.S. Pat. No. 5,837,882 are generally designed to evaluate material performance and require that a sample to be tested be prepared of predefined dimensions so as to fit the test apparatus and as such is limited to evaluating a sample of the material and not the actual finished product. The known prior art also utilizes a plurality of spherical bearings to apply the load to the test element which yields a less significant near circular contact shape as compared to an elliptical contact shape with a width much greater than its length when the load is applied using cylindrically shaped idler rollers.

The invention accordingly fulfills a need that exists in the known prior art for a more versatile and more realistic test assembly, i.e., for a machine whereby the actual production specimen of manufactured parts may be evaluated.

### SUMMARY OF THE INVENTION

The invention provides a fatigue test machine useful in performing accelerated rolling contact fatigue endurance tests on the bearing rollers used in roller finger followers and tappets and allows verification of the performance of production parts and permits valid comparisons with new material roller designs.

The machine of the invention affords the capability for evaluating roller materials and roller crown geometry because it accurately simulates the cam-roller contact geometry using an actual bearing roller as the test specimen. It also provides the capability of evaluating the effects on the rollers of cam finish, of cam profile, of oil condition, and of alignment relative to a cam. In a first of three alternative embodiments of the invention, three idler roller assembles with the outer diameter ground to simulate the actual cam profile and surface finish are comprised by means of hydraulic cylinders into the outside diameter of the bearing roller under test as it rotates, thereby essentially duplicating the rolling action of a cam lobe. Because the bearing roller under test is loaded evenly between the three idler roller assemblies, it experiences three stress cycles per revolution, accelerating the generation of fatigue spalling damage on the outer diameter. Load and speed are regulated using a closed loop control program of a standard commercial computer. Ease of replacing baring rollers under test and servicing the idler roller assemblies is an attractive feature of the machine of the invention.

Lubrication for the bearing roller and the idler roller assemblies is supplied by a recirculating oil system with oil temperature regulated as needed, either by heating or cooling, using a closed loop control, to monitor the viscosity of the oil in the bearing roller-idler roller interface. The oil may be brought up to the specified temperature before the motor is started and the load is applied to the test part. Failure of a test specimen or one of the idler roller assemblies is determined by the increase in signal output from an accelerometer located to detect the changes in the vibration level that occur when a spall develops in the surface of a roller. The controls for the machine comprise a commercially available computer that is programmed to permit continuous operation of the machine with automated shut off for test specimen failure or upon reaching a predetermined number of revolutions of the test specimen.

The invention is devised with the capability of testing a finished production part simulating a commercial customer application of the part and is adaptable to a range of outre diameters, inner diameters and widths of a cylindrically shaped test specimen. The configuration of the machine of the invention comprises three cylindrically shaped rollers that apply a load to the cylindrical specimen mounted on the spindle as distinguished from other means such as spherical rolling elements described in the prior art. Consequently, the invention creates an elliptical contact shape between the idler rollers and the test specimen whose width along the axis of rotation is much greater than its length in the cylindrical direction and is often referred to as a “line” contact. This contact shape is significantly different from the near circular contact ellipse that exists between the prior art's spherical rolling elements and the test specimen. Another significant difference in the nature of the contact feature provided by the apparatus of the invention involves the adjustment of the “line” contact between the cylindrical bodies. The invention includes provisions to align the axes of rotation of the test specimen and the idler rollers to ensure that the axis of rotation of each idler roller lies in a plane with the axis of the test specimen. This alignment directions is often called “skew.” The other alignment concern is within the common plane of the test specimen and each idler roller. The angle between the two axes of rotation—i.e., the angle between the test specimen and an individual idler roller within the plane is referred to as “tilt.” The invention contains provisions to align the idler rollers in theses two directions. A description summary of the fatigue test apparatus of the invention is presented at page 29 of the May 2006 issue of TEST & MEASUREMENT WORLD, which is incorporated in its entirety herein by reference.

The “skew” and “tilt” adjustments of the invention also enable a testing method, which examines the interactions of the test specimen and idler roller surfaces. Different surface finishes can be tested with different amounts of skew and tilt to examine the effects of these parameters on either the surface or sub-surface initiated failure modes.

In a second alternative embodiment of the invention can be reconfigured to test a range of tappet assemblies, which consist of a cylindrical roller with an inner diameter, a pin or axle about which the roller rotates and tappet body into which the pin or axle is secured. This second configuration enables the evaluation of three test specimens simultaneously by mounting the tappet assemblies in mounting fixtures attached to the machine in place of the three idler roller assemblies. By means of a hydraulic cylinder, the machine compresses the tappet assembles into a cylindrical driving roller mounted on the motor spindle. In this configuration the invention permits the assessment of the durability of a bearing roller and axle combination. Different axle materials, bearing roller inner diameter conditions, or geometric clearances can be evaluated in this configuration. In addition, utilizing the “skew” and “tilt” adjustments of the invention enable the evaluation of the wear and durability performance of the tappet assemblies under misaligned conditions.

A third embodiment, the machine of the invention is similar to the second embodiment with the exception that the pin or axle is fitted with a torque transducer. The configuration enables the measurement of the bearing torque under a variety of load, alignment, and temperature conditions, which can be used to evaluate the performance of roller inner diameter conditions, or geometric clearances can be evaluated in this configuration using torque as the measurement parameter.

### BRIEF DESCRIPTION OF THE FIGURES

FIG. 1 is a side elevational view partially in cross-section of the roller fatigue test assembly of the invention shown in conjunction with a control console

FIG. 2 is a partial enlarged side view of an assembly of FIG. 1 with safety cover omitted.

FIG. 3 is a top view of an assembly of FIG. 1.

FIG. 4 is top view of the roller fatigue portion of the test machine.

FIG. 5 is an enlarged partial cross sectional side view of the bearing roller, the spindle assembly and the idler roller assembly of FIG. 1.

FIG. 6 is a side view partially in cross section of a modified configuration of the test assembly.

FIG. 7 is a top view partially in cross section of a load assembly and the driving roller of the alternative embodiment of FIG. 6.

FIG. 8 is a side view partially in cross section of a third alternative embodiment of a testing apparatus of the invention.

### DETAILED DESCRIPTION OF THE INVENTION

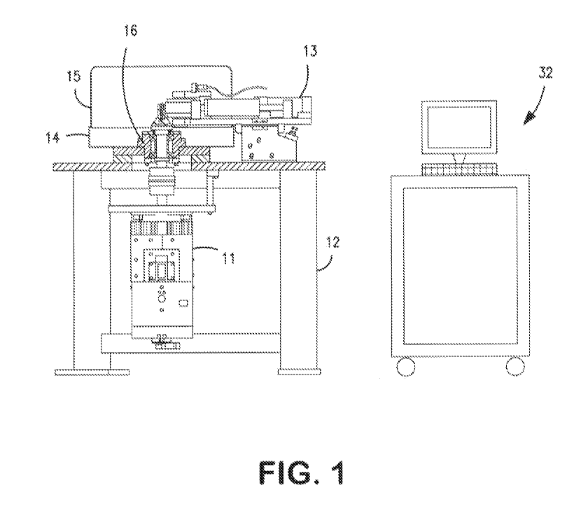

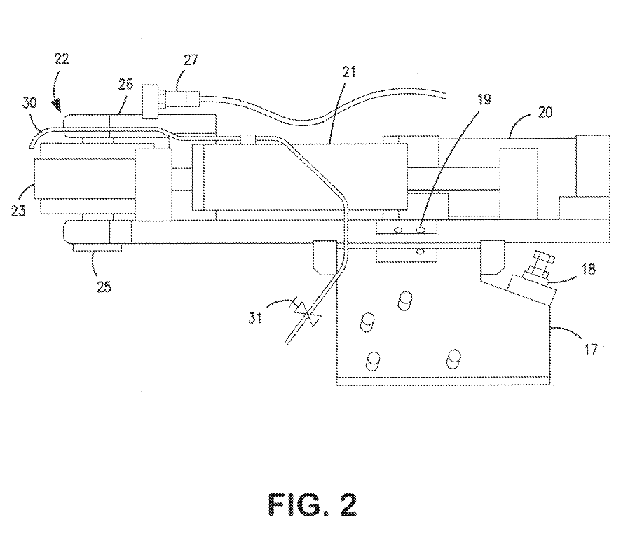

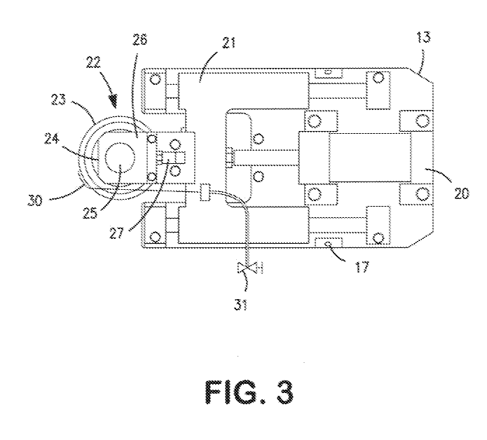

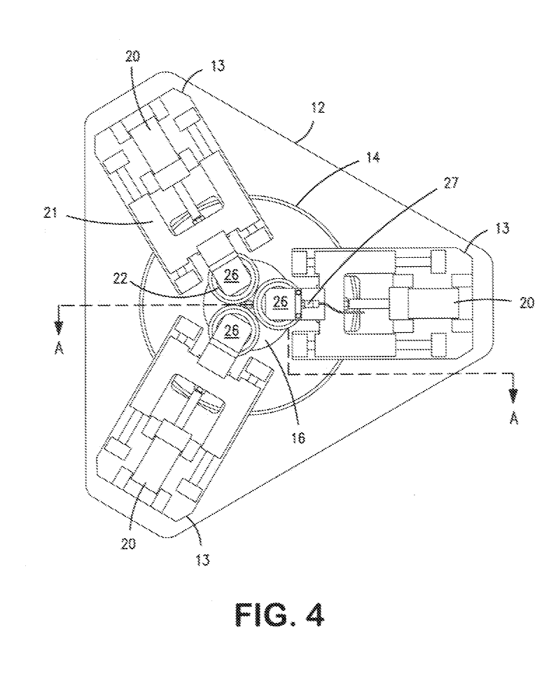

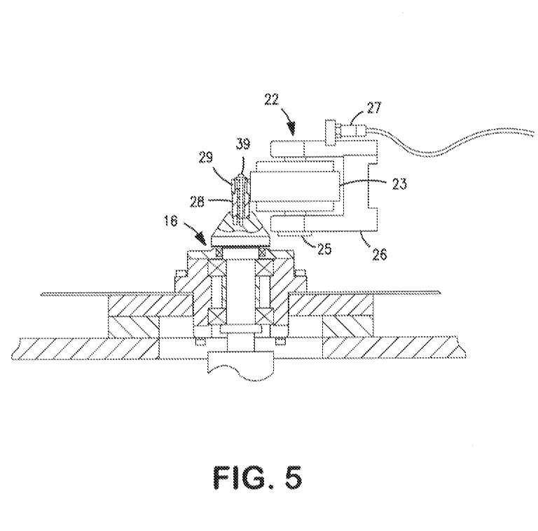

In the first embodiment of the testing machine of the invention as shown in FIG. 1, the test machine is comprised of a vertically oriented electric motor 11 that is suspended below a table-like frame 12. Mounted on top of the frame 12 are three load assemblies 13, an oil catch tray 14, a safety cover 15 and a spindle assembly 16. As shown in FIGS. 2 and 3, the load assembly 13 is comprised of a base 17 with tilt adjustment 18 and skew adjustment 19, on top of which is mounted a hydraulic cylinder assembly 20 and a cylinder carrier 21, the details of which are shown more clearly in FIG. 3 and which is guided by linear bearings (not shown?). Mounted to the carrier 21 alternatively may be either an idler roll assembly 22 or a tapped-mounting fixture (not shown) for securing tappet assemblies or similar assemblies. The idler roller assembly 22 is comprised of an idler roller ring 23 with a prescribed surface profile and finish, one or two rolling element bearings 24, a shaft 25 and a yoke assembly 26. An accelerometer 27 is mounted on one of the yoke assemblies 26. As shown in FIG. 4, the three load assemblies 13 are mounted at 120 degrees relative to each other on the table-like frame 12 arranged so that the spindle assembly 16 is central to the three load assemblies 13. The hydraulic cylinder 20 on each of the three load assemblies 13 are connected in parallel to a commercially available hydraulic power pack (not shown). The bearing roller 29 to be tested (see FIG. 5) is fitted on a collet 28, which is located on and secured by bolts 39 to the spindle assembly 16. Lubrication is supplied from a commercially available lubrication tank (not shown) by a pump via a feed line passing through valve 37 to nozzles 30 located on each of the three load assemblies 13.

A control station 32 shown in FIG. 1 is comprised of commercially available components which include a computer, an electric motor controller, data acquisition computer interface cards, fuses, proportional-integral-derivative controllers, electronic relay switches and transformers. In accordance with the invention, the control station 32 is arranged to comprise a computer program devised to monitor the following functions: 1) regulate the oil temperature so as to heat or cool the lubricating oil such as by use of a thermocouple and an immersion heater; 2) regulate pressure to the hydraulic cylinders 20; 3) regulate the rotational speed of the electric motor 11; 4) monitor safety switches; and 5) receive the signal from the accelerometer 27. Signals from the accelerometer 27 received by the computer program in the control station 32 are analyzed with a Fast Fourier Transform (FFT). The computer program is capable of monitoring a multitude of different arbitrary frequency bands in the FFT, which is updated regularly. Within the computer program two separate vibration acceleration amplitude limits can be set for each arbitrary frequency band of the FFT, one to trip an alarm limit and the second “stop test” limit to unload the part and shut the machine down. Additionally, the computer program in the control station 32 records the peak acceleration amplitudes of each frequency band during the course of a test, the load exerted by the idler roller assemblies 22 on the bearing roller 29, the rotational speed of the electric motor 11 and hence the bearing roller 29, and the temperature of the lubricant. A counter, integral to the electric motor 11, is employed to record the number of shaft revolutions during a test.

In preparation for a test the operator adjusts the load assemblies 13 to the desired alignment of “tilt” and “skew.” The idler roller rings 23 can be manufactured from a desired material to represent the conditions that may exist in the actual application of the bearing roller 29 and, for example, manufactured using a process which can create a surface geometry profile and finish that represents conditions that may exist in the actual application of a piece to be tested, e.g., the bearing roller 29. Various commercially available lubricants can be used in the invention to change the elastohydrodynamic lubrication characteristics that exist in the contact area between the idler roller ring 23 and bearing roller 29. Nozzle 30 position and lubrication flow can be adjusted to desired conditions with the oil flow control valve 31.

Prior to starting a test, the machine of the invention can be operated in a manual mode whereby an operator has full control of the applicable operating parameters. In the manual mode the operator can establish the test parameters for load, speed and lubricant temperature before recording data relating to test signals on actual specimens derived from the accelerometer 27 that are processed with FFT by the control station 32. The operator can then set-up warning and “stop test” vibration amplitudes for a multitude of arbitrary frequency bands at the control station 32 by referencing a previously recorded accelerometer signal FFT. Means are provided for measuring the amplitude in multiple selected frequency bands of the vibration generated by the rolling contact between the idler bearings and the specimen under test. In addition, the operator can define the maximum number of revolutions for the test specimen.

Once these test parameters have been established, the operator starts a test in an automatic mode whereby the computer program in the control station 32 will signal warnings when test parameters fall outside prescribed limits or when vibration acceleration amplitudes within any of the multitude of arbitrary frequency bands have reached a warning limit. Control station 32 programming is device to stop a test if any of the safety switches are activated, when vibration acceleration amplitudes have reached the “stop test” limit in any of the multitude of arbitrary frequency bands or when the bearing roller 29 has reach the maximum number of revolutions limit defined for the test by the operator.

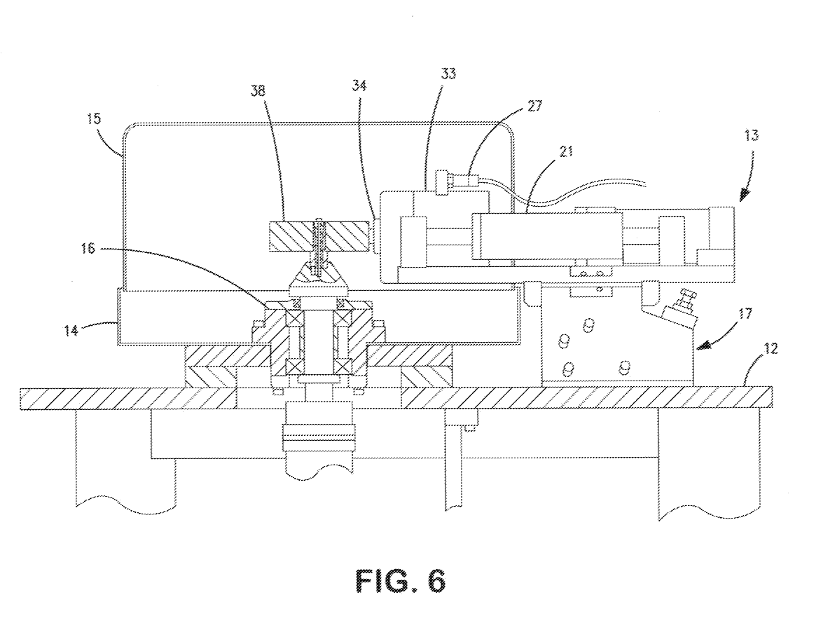

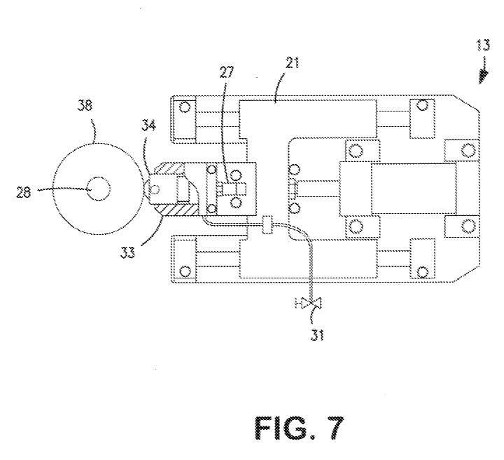

In an alternative embodiment of the invention as shown in FIGS. 6 and 7, a driving roller 38 is attached to the spindle assembly 16 in place of the collet 28, shown in FIG. 5 and a tappet mounting fixture 33 is used to secure a tappet assembly 34 to the carrier 21 on each load assembly 13 in place of the idler roller assemblies 22. An accelerometer 27 for recording and analyzing test signals that are used to trigger warnings or shut the machine down when damage to a specimen occurs is secured to one of the tappet mounting fixtures 33. In this embodiment, a lubricant can be supplied at controlled temperatures and pressure to the tappet mounting fixture 33 and tappet assembly 34 simulating actual application conditions for the tappet assembly 34. As with the first embodiment of the invention, the load assemblies 13 can be adjusted to the desired “tilt” and “skew,” and a signal from the accelerometer 27 is received, analyzed and monitored in the same manner. Test parameters and limits are established also in the same manner as described with reference to the first embodiment of the invention, and the automated function of the control station 32 is the same. The embodiment described with reference to FIG. 7 enables the evaluation of three tappet assemblies 34 simultaneously using the signal from the accelerometer 27 monitored after processed with FFT in any of the multitude of arbitrary frequency bands to detect an end of test condition according to the method described in the first configuration. In the embodiment as well as the embodiment described with reference to FIG. 3, a test can be stopped based on a define number of revolutions of the electric motor 11, as well.

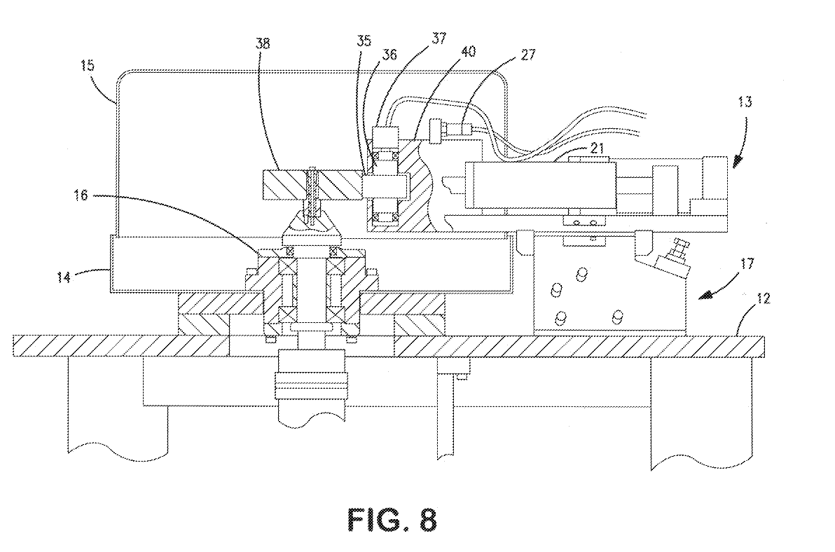

In a further alternative embodiment as illustrated by reference to FIG. 8 the torque between a rotating journal-bearing roller 35 and a journal-bearing shaft 36 can be evaluated. Similar to the embodiment described with reference to FIG. 7, in the embodiment described in reference to FIG. 8, a driving roller 38 is attached to the spindle assembly 16. A journal bearing fixture 40 is secured to the carrier 21 in place of tappet mounting fixture 33 of the second configuration on any or all of the three load assemblies 34. A torque transducer 37 is mounted so as to measure the torque between the journal bearing shaft 36 and the journal bearing roller 35 while being driven under load by a driven roller 38. The signal from the torque transducer is unique to the embodiment of FIG. 8 but is received by the control station 32 where it can be monitored during a test. Similar to the arbitrary frequency bands of the FFT of accelerometer amplitude signal, a warning limit and a “stop test” limit can be established by the operator for the signal from the torque transducer. Pressurized oil may be supplied to the interface between the journal bearing roller 35 and the journal bearing shaft 36.

The test machine of the invention is designed to evaluate surface initiated failure modes, such as microspalling and also subsurface failure modes such as fatigue spalling that occur on bearings rollers 29 in highly loaded elastohydrodynamic rolling contact regimes. In the embodiments referred to in FIGS. 6 and 8, the machine can also assess the life and frictional losses of a journal bearing type interface. The principle of the machine is to load bearing roller 29, or tappet assemblies 34, or a journal baring roller 35 with either a low rolling friction idler roller 22 to create stress cycles on the test roller surface, or with a driving roller 38 to rotate a bearing roller 29 about a pin or axle in a tappet assembly 34. When the stress cycles eventually cause a fatigue crack below the surface of the test sample, the machine is designed to detect when the first loss of material from the test sample occurs. The machine accomplishes this by monitoring the magnitudes of the system vibrations in up to five arbitrarily selected frequency bands. As material is lost from the surface of the test sample, the acceleration level increases due to the roughened surface of the test sample or after a prescribed number of revolutions have occurred or after the signal from the torque transducer has reached a “stop test” limit. While the invention contemplates primarily a system for testing production cylindrical metal parts it will be apparent that the invention may be applied also to test cylindrical manufactured parts of suitable thermoplastic and thermosetting plastic components such as, nylon, polyolefuis, polycarbonates and various commercially available fluorinated plastic compositions.

It will be understood that the invention has been described in an illustrative manner and that minor modifications obvious to one skilled in the art are contemplated in the light of the above description. Accordingly, various modifications may be made without departing from the scope of the invention as defined in the claims which follow.

What is claimed is:

1. An assembly for testing in line contact rolling contact fatigue performance characteristics of the inner and outer diameter of finished cylindrical manufactured part said assembly comprising:
a. a frame for vertically mounting a motor;
b. a speed controllable motor with a driven rotable spindle coupled to and driven by said motor mounted on said frame;
c. means for securely mounting a cylindrical manufacture part to be tested on said driven spindle;
d. three load assembly bases disposed at 120 degrees to each other and having said motor and spindle located centrally between said bases;
e. three hydraulic load cylinders activated by a controllable hydraulic means mounted on said load assembly bases, each of which is provided with and activates a precision-guided horizontal-acting carrier and an idler bearing assembly, the axis of such idler bearing assemblies being essentially parallel relative to the central axis of the motor and spindle;
f. means to adjust the axes of rotation of each of the idler bearing assemblies to control the axis of rotation of each idler roller relative to the axis of the spindle-mounted specimen being tested; and
g. means of providing oil lubrication to the interface between the idler bearing assembly and the surface of the manufactured part under test, and to the rolling element bearings in the idler bearing assemblies.

2. The assembly of claim 1 including means to heat or cool the lubricating oil to control the viscosity of the oil.

3. The assembly of claim 1 including means for measuring the amplitude in multiple selected frequency bands of the vibrations being generated by the rolling contact between the idler bearings and the surface of the cylindrical manufactured part;

4. The assembly of claim 1 including an accelerometer for recording and analyzing test signals and using the signals output to trigger warnings or to shut the machine down when damage to a specimen under test occurs.

5. The test assembly of claim 1 provided with three tappet mounting fixtures for holding and aligning tappet-like assemblies with one fixture mounted to each of the three horizontal-acting carriers and wherein the axis of the tappet assembly bearings or bearings under test are to be essentially parallel relative to the central axis of the motor and spindle.

6. The test assembly of claim 5 provided with means of securely mounting a driving roller on the rotatable spindle wherein the surface finish and profile of the outer diameter of the driving roller are subjected by rolling contact to a desired variable test conditions, and means to providing oil lubrication with sufficient pressure to a tappet assembly, and to the interface between the driving roller and tappet assembly bearing outer diameters.
